(19) United States
(12) Patent Application Publication
(10) Pub. No.: US 2007/0035148 A1
(43) Pub. Date: Feb. 15, 2007

(54) Motor vehicle comprising a passenger cell in the form of a separate unit

(76) Inventors: Gunther Ellenrieder, Esslingen (DE); Wolfgang Fussnegger, Tubingen (DE); Jens Manske, Tschechische (DE); Peter Pfeiffer, Boblingen (DE)

Correspondence Address: AKERMAN SENTERFITT, P.O. BOX 3188, WEST PALM BEACH, FL, 33402-3188, US

(21) Appl. No.: 10/533,354

(22) PCT Filed: Sep. 23, 2003
(86) PCT No.: PCT/EP03/10556

§ 371 Date: Oct. 25, 2006

(30) Foreign Application Priority Data
Oct. 29, 2002 (DE) 102 50 290.0

(51) Int. Cl. B62D 24/04

(52) U.S. Cl. 296/35.1

(57) ABSTRACT

The invention relates to a motor vehicle (1), the passenger cell (2) of which is integrated into the rest of the vehicle as a separate unit. The motor vehicle (1) has a device, by means of which, in the event of a crash, the passenger cell (2) can be moved in the longitudinal direction of the vehicle relative to the rest of the vehicle and at the same time upward, via guide surfaces (15), which are arranged on the rest of the vehicle and against which the passenger cell (2) bears. In order to reduce the risk of injury for the vehicle occupants in the event of a crash, it is proposed that the device be designed in such a manner that the passenger cell (2) can be moved in the opposite direction to the impact.

### BACKGROUND OF THE INVENTION

1. Field of the invention

The invention relates to a motor vehicle according to the precharacterizing clause of patent claim 1.

2. Related Art of the Invention

A motor vehicle of the generic type is disclosed in DE 41 02 526 A1. A device is described there which comes into operation during a head-on collision of the motor vehicle with an obstacle and raises the passenger cell, which is designed as a unit decoupled from the rest of the vehicle, upward at its front side, so that the passenger cell is detached there from resting on the rest of the vehicle. At the same time, a motor-driven cable pull is set into operation, said cable pull being fastened at one end to the rear side of the passenger cell and at the other end to a reel, which is fitted on a vehicle in the front region of the passenger cell and on which the motor exerts its torque. The cable pull is then rolled up onto the reel, as a result of which the passenger cell, which is guided in the rear region on the rest of the vehicle by means of a roller/rail system, is rotated about a rotation point. In the end position, the passenger cell is erected vertically, i.e. points with its front side upward and is therefore withdrawn from the immediate region of the crash. However, a disadvantage of this vehicle concept is that, in the event of a head-on collision of the vehicle, the passenger cell is accelerated forward particularly severely in the impact direction not only by the inertial force of the passenger cell, but also by the tensile force of the cable pull, with the result that the passenger cell is catapulted obliquely forward over the front end of the vehicle. If, in this case, the crash takes place with high obstacles, for example trees, walls or commercial vehicles, it is highly likely that the occupants of the passenger cell will be exposed to a particularly high risk of injury.

### SUMMARY OF THE INVENTION

The invention is based on the object of developing a motor vehicle of the generic type to the effect that the risk of injury for the vehicle occupants in the event of a crash is reduced.

The object is achieved according to the invention by the features of patent claim 1.

By means of the movement of the passenger cell counter to the impact direction in the event of an impact, an additional crash length is obtained at which kinetic impact energy can be absorbed without the passenger cell incurring damage in the process. Although the vehicle occupants do not experience a more gentle jolt, the passenger cell remains intact over the abovementioned crash length even from intrusions. The risk of injury for the occupants is thus considerably reduced. Owing to the obtained high increase in crash safety of the passenger cell, other complicated safety precautions customarily used thereon, such as, for example, additional stiffening structures or crumple zones, can be reduced or even omitted without the safety of the occupants thereby being put at risk. In consequence, simpler constructions of the passenger cell and therefore of the entire vehicle are made possible. In this case, the use of a passenger cell composed of dimensionally stable plastic would be conceivable.

### BRIEF DESCRIPTION OF THE DRAWINGS

Expedient refinements of the invention can be gathered from the subclaims; furthermore, the invention is explained in more detail below with reference to a plurality of exemplary embodiments illustrated in the drawings, in which:

FIG. 1 shows, in a perspective view, a motor vehicle according to the invention with a passenger cell, in the installation position,

FIG. 2 shows, in a perspective view, the motor vehicle according to the invention from FIG. 1 with a passenger cell, in the case of a head-on collision,

FIG. 3 shows, in a perspective view, the rest of the motor vehicle body surrounding the passenger cell, with a device according to the invention for displacing the passenger cell,

FIG. 4 shows, in a detail in a perspective view, a motor vehicle body, which surrounds the passenger cell, of a motor vehicle according to the invention, with a length-changeable longitudinal member.

### DETAILED DESCRIPTION OF THE INVENTION

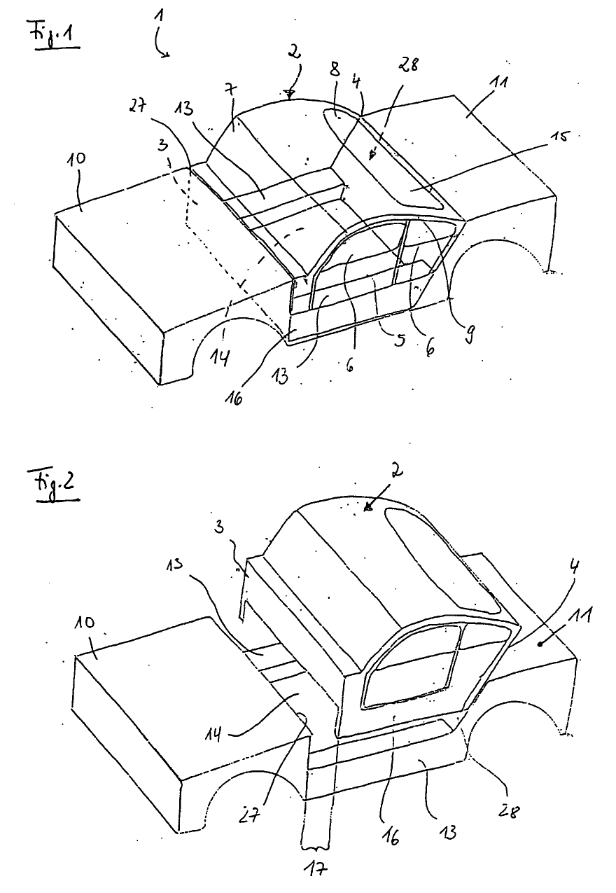

FIG. 1 illustrates a motor vehicle 1, the passenger cell 2 of which is integrated into the rest of the vehicle as a separate unit. In this case, the passenger cell 2 comprises a front spray wall 3 and a rear back wall 4 and also doors 5 having windows 6, a windshield 7, a rear window 8 and a complete roof structure 9. The rest of the vehicle contains a front end 10 with a drive unit of the motor vehicle 1 and a rear end 11 with a trunk, which ends are connected to each other by two lateral longitudinal members 13, with the extent of the longitudinal members 13 between the front end and the rear end 10, 11 forming the sill region of the motor vehicle 1.

The front end 10 and the rear end 11 together with the longitudinal members 13, which are part of a vehicle structure situated essentially below the passenger cell 2, form a trough 14, which is connected to the front end 10 by means of a vertically running wall 27 and to the rear end 11 in the form of a wall 28 with an obliquely running guide surface 15 which faces the front end 10. In this exemplary embodiment, the form of these connections is designed in a suitable manner for a head-on collision. As an alternative, on the one hand, instead of the step-shaped wall 27 a wall with an obliquely running guide surface which faces the rear end 11 is likewise conceivable, as a result of which the invention can advantageously be used even in the case of a rear impact, for example in the case of a rear end collision. On the other hand, said oblique guide surface 15 may also only be arranged at the front end solely for the purpose of safety during rear end collisions.

The passenger cell 2 is fitted into the trough 14, the passenger cell 2 sitting on the longitudinal members 13 and covering the latter outward with a skirt 16. In the case of an impact-induced displacement, this skirt 16 is used to obtain stable longitudinal guidance of the passenger cell 2 along the longitudinal members 13 (FIG. 2). The profile of the rear back wall 4 and of the front splash wall 3 of the passenger cell 2 are designed in accordance with the forms of connection of the front end 10 and of the rear end 11. Under normal operating conditions, the passenger cell 2 is securely fixed to the rest of the vehicle, for example to the front end and rear end 10, 11, by fastening means. These may be designed in such a manner that, when a defined, acting moment of force is exceeded, they become detached, for example by unlocking, or are provided with predetermined breaking points at which the fixed connection between the passenger cell 2 and the rest of the vehicle tears off from said moment of force, so that said passenger cell is moveable relative to the rest of the vehicle.

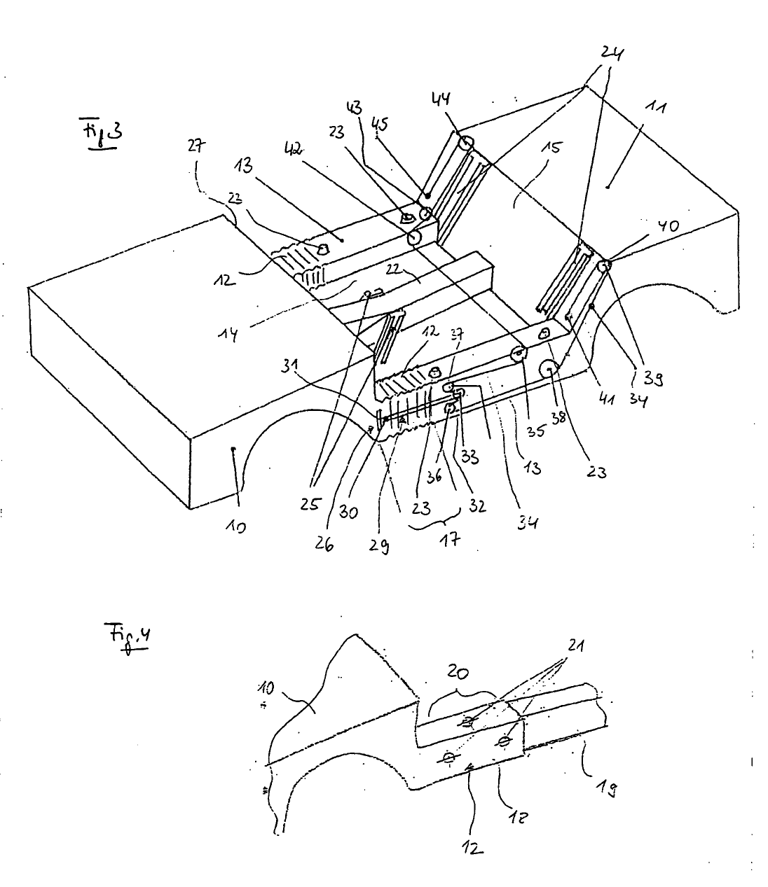

Furthermore, elastic bearings, preferably rubber bearings 23 (FIG. 3), can be arranged on the rest of the vehicle, in particular on the longitudinal members 13, on which bearings the passenger cell 2 rests, as a result of which the occupants of the passenger cell 2 experience an improvement in terms of comfort of the driving sensation, which improvement results from the vibration decoupling, which is associated with the rubber bearing, from engine vibrations and from vibrations induced by unevennesses in the carriageway. In a simple manner in terms of installation, the rest of the vehicle may comprise individual modules, namely a front end module, a rear end module, and longitudinal member modules.

The motor vehicle 1 furthermore contains a device for moving the passenger cell 2 in the longitudinal direction of the vehicle relative to the rest of the vehicle. If, during the driving mode, a head-on collision occurs, the device is activated at the same time or shortly beforehand by means of crash sensors. The device then moves the passenger cell 2 rearward and at the same time upward in the opposite direction to the impact via the guide surface 15 of the rear end 11, with the fastening means being detached or breaking off because of the movement. The fastening means may also be controlled with the assistance of sensors, in particular may already be detached before the impact. When the passenger cell 2 moves rearward and upward, it is spaced apart from the wall 27 of the front end 10 by an additional crash path 17, as a result of which the motor vehicle 1 can absorb substantially more impact energy than in the case of hitherto known crash systems, without the passenger cell 2 being damaged. In this connection, the bevel angle of the guide surface 15 plays an important role. The shallower said angle is, the greater is the available additional crash path 17, with small angles providing particularly great security for the occupants of the passenger cell 2. However, when realizing the vehicle 1 according to the invention, the bevel-angle design has to be matched to the length of the rear end 11 and therefore to the overall length of the vehicle 1 and the dimensioning of the trunk, which limits the ability to select any desired angle. The invention is particularly favorable in the case of motor vehicles 1, the passenger cell 2 of which is completely self-sufficient, i.e. when the steering system and brake are actuated electrically and there are no mechanical connections from the passenger cell 2 to the chassis, since this enables the passenger cell 2 to be moved rearward and upward entirely without obstruction.

On the additional crash path 17, the vehicle structure has a section 12 which can be pushed together in the longitudinal direction of the vehicle and here constitutes part of the longitudinal members 13 in the sill region, as clarified in FIGS. 3 and 4. According to FIG. 3, the section 12 can be folded in the manner of a concertina, with it buckling in the transverse direction of the vehicle. As a result, in the event of a crash, a further, additional deformation path is available, with it being possible for the deformation to be initiated in a specific manner, so that the motor vehicle 1 can be pushed together in a defined direction on this section 12. By means of this measure, the occupants of the passenger cell 2 experience a softer jolt during the impact, with impact energy being consumed at the same time.

As an alternative to this, according to FIG. 4 the longitudinal members 13 may also comprise a plurality of components 18 and 19, the first components 18 being of hollow design and engaging around the second components 19, with an overlapping zone 20 being formed and with an empty distance being left free, over which the second components 19 can be displaced longitudinally in and relative to the first components 18 in the event of a crash. The components 18 and 19 are inserted in one another in a simple manner and are fastened to one another along the overlapping zone 20 with connecting means 21 which can be sheared off in the crash, for example by means of screws. In the event of a crash, the connecting means 21 break, so that the two longitudinal member parts 18 and 19 telescope one inside the other. By this means, on the one hand, impact energy is likewise dissipated and, on the other hand, the jolt is made more gentle. This section 12 designed in a particularly energy-saving manner, as illustrated by way of example in FIG. 3 and FIG. 4, may also be formed on a central tunnel 22 (FIG. 3) of the vehicle structure.

The device by means of which the passenger cell 2 can be moved in the opposite direction to the impact, may be embodied in a number of variants. For example, the device can contain a crash sensor and one or more compression springs which are supported, on the one hand, on an end wall of the passenger cell 2, for example the front splash wall 3, and, on the other hand, on a stop formed on the rest of the vehicle and, in this case of the sheet-like wall 27, is formed on the front end 10. The passenger cell 2 is locked to the rest of the vehicle, with the crash sensor canceling the locking after detection of an impact or a shortly imminent crash. Instead of the compression springs, use may also be made of tension springs which are then, however, supported at one end on the rear end 11 and at the other end at the rear back wall 4 of the passenger cell. If, in the event of a crash, the locking, which is formed by a lock, of the passenger cell 2 is canceled, the compression or tension springs, which are under prestress, relax, whereupon the passenger cell 2 is pushed or pulled by them rearward and upward along the guide surface 15.

It is conceivable, in a further variant of the device, for the device to contain a crash sensor and a pyrotechnic device which is arranged between the end wall (front spray wall 3), which faces the impact direction, of the passenger cell 2 and an opposite wall, here the sheet-like, step-shaped wall 27 of the front end 10, of the rest of the vehicle. After detection of an impact or of a shortly imminent impact, the crash sensor uses an electric signal to activate an igniter of the device, whereupon, via the pyrotechnics, an explosive pressure is released that pushes the passenger cell 2 within an extremely short period of time rearward and upward. In the case of the above-described variants, it is very beneficial for an as unhindered a displacement as possible of the passenger cell 2 counter to the impact and therefore for ensuring a satisfactory functioning of the device according to the invention if the guide surface 15 is beveled at an angle which is at most 45°.

For improved guidance, on the guide surfaces 15 are arranged running rails 24 which run parallel to one another and along which the passenger cell 2 is guided in a defined direction, so that, in the event of a crash, an uncontrolled displacement movement of the passenger cell 2 does not occur. The running rails 24 may be grooves which run rectilinearly and are incorporated into the guide surfaces 15, with webs or a plurality of pins which engage in the grooves being arranged on the splash wall 3 or the back wall 4. As an alternative, the running rails 24 themselves may constitute webs which are fitted with play into channels or grooves formed on the passenger cell 2. In order to increase the ease of guidance and in order to maintain a stable horizontal position of the passenger cell 2, there are likewise also formed on the vehicle structure, in this exemplary embodiment on the central tunnel 22 in the vicinity of the front end, running rails 25 which interact with corresponding guide means on the bottom of the passenger cell 2. Owing to the guides, which are arranged at the front and rear and on the left and right of the passenger cell 2 and are all parallel to one another and face obliquely upward to the impact direction, during a vehicle collision the entire passenger cell 2 is moved upward and rearward in a uniform parallel displacement, thus preventing tilting movements, which impair the sitting comfort of the occupants and possibly lead to health risks. Furthermore, the passenger cell 2 can be inserted exactly into the trough 14 via the rail guide in an easy-to-install manner and can be positioned there, after which the passenger cell 2 is fixed in the fitted position by locking.

As an alternative to the above-described variants of the pyrotechnics and the spring drive, FIG. 3 shows the device for moving the passenger cell 2 a sliding element 29 which is arranged along the longitudinal direction of the vehicle and can be actuated in the longitudinal direction of the vehicle by the impact force of a vehicle crash. The rigid sliding element 29 is connected at one end to the passenger cell 2 over the entire crash path and at the other end bears an impact receptacle 26, which is fitted to the front end 10 or to the lower vehicle structure in a manner secured on the vehicle. By this means, without an outlay on sensor technology, the impact energy itself is used in a simple manner in order to move the passenger cell 2 upward and rearward. In the process, crash energy is additionally consumed. In order to achieve an application of force which is as uniform as possible, it is expedient to provide a plurality of sliding elements 29 which are arranged parallel to one another and end flush with one another in the impact direction. The sliding elements 29 are to be fastened to the front end 10 or to the vehicle structure which is situated below the passenger cell 2 in such a manner that the sliding elements 29 are moveable in the longitudinal direction of the vehicle relative to that section 12 of the vehicle structure which is to be pushed together, i.e. the sliding elements 29 must not have any direct contact with the section 12. The effect achieved by this is that the passenger cell 2 can be moved rearward in as an unhindered a manner as possible over the additional crash path 17 provided by the section 12. Of course, for a rear crash, one or more sliding elements 29 may also be fitted to the rear end 11. It is also conceivable, for a continuous movement of the passenger cell 2 which reaches as far as possible, in the event of fitting the sliding elements 29 on the front end or rear end 10, 11, to form the walls 27, 28 of said sliding elements, which walls are adjacent to the vehicle structure situated below the passenger cell 2 and to the spray walls 3, 4 of the passenger cell 2, in such a manner that, in the event of a crash, the structure penetrates the walls 27, 28, with the longitudinal members 13 only running between the front end and the rear end 10, 11 in this variant. The sliding element 29 is structurally designed as a push rod 30 with an actuating plate 31, the latter forming the impact receptacle 26.

The impact receptacle 26 may also be mounted upstream of the passenger cell 2 in such a manner that it protrudes over the front end 10 in the longitudinal direction. In this case, the impact receptacle 26 is not to be fastened to the front end 10 or to the lower vehicle structure and the push rod 30 is to be guided merely on the front end 10 or on the lower vehicle structure, so that the push rod 30 with the actuating plate 31 can execute movements in the longitudinal direction of the vehicle relative to the front end 10 and to the lower vehicle structure. The passenger cell 2 is thus already pushed back automatically before the impact of the front end 10, as a result of which the additional crash path 17 becomes free at an early point and the passenger cell 2 is especially protected against intrusions. In this connection, the additional negative acceleration on the occupants, which acceleration occurs due to the passenger cell 2 being moved back, is shifted to a different moment of time than the following, crash-induced negative acceleration, with the result that the occupants are not exposed to such high loads on their bodies as in the case of isochronous accumulating negative accelerations. Owing to mounting the impact receptacle 26 upstream and to the resultant, early exposure of the additional crash path 17, it is possible to entirely omit the configuration of the section 12 in which it can be pushed together, which considerably reduces the outlay on manufacturing the vehicle 1 without greater losses in crash safety being the consequence.

In the exemplary embodiment of FIG. 3, a sliding element 29 arranged on the left side of the motor vehicle 1 has, at the end 32 lying opposite the impact receptacle 26, a rotatable deflection pulley 33 which engages in a cable pull 34. On the one hand, the cable pull is fastened via the deflection pulleys 35, 36, 37, 38, which are fastened rotatably to the longitudinal member 13, on the left side of the vehicle to a deflection pulley 39, which is fastened rotatably to the upper edge 40 of the guide surface 15 of the rear end 11. The end 41 situated there of the cable pull 34 is fitted on the left side of the rear back wall 4 of the passenger cell 2. On the other hand, the cable pull 34 is guided above the central tunnel 22 via the deflection pulley 35 to the right side of the vehicle onto a deflection pulley 42 on the longitudinal member 13 there and from there first of all to a deflection pulley 43, which is likewise fastened to the right longitudinal member 13, and finally to a deflection pulley 44 which is fitted on the right side of the guide surface 15 of the rear end 11. The end 45 of the cable pull 34 is fastened on the left side of the rear back wall 4 of the passenger cell 2. In the event of a crash, the sliding element 29 is displaced in the longitudinal direction relative to the passenger cell 2 and, in the process, is pressed into the cable pull 34 which, owing to the shortening taking place in the process of the rest of the length of cable, places the passenger cell 2 under a tensile stress in the direction of the rear end 11. By pulling the passenger cell 2 away from the impact region upward along the guide surfaces 15, the risk of intrusions of the rigid sliding elements 29 into the passenger cell 2, which risk possibly exists if the sliding elements 29 are directly attached to the front splash wall 3 of the passenger cell 2, is basically avoided. By means of the tension acting with equal effect on both sides, the passenger cell 2 is moved along the guide rails 24 of the guide surface 15 uniformly and without becoming stuck. The cable pull variant furthermore affords the advantage that the movement of the passenger cell 2 along the guide surface 15 is virtually independent of the bevel angle and nevertheless can take place without obstruction. This achieves a greater possibility of variation in the design of the vehicle.

As an alternative, it is also conceivable for one cable pull 34 to be arranged in each case on both sides of the vehicle 1, the two ends of the cable pull 34 being fitted in each case on the left and right side of the rear back wall 4 of the passenger cell. It is thereby ensured that the passenger cell 2 can still be pulled even if one cable pull 34 tears under the crash conditions. Furthermore, a transverse guide of the cable pull 34 from one longitudinal side of the vehicle to the other, which transverse guide may be obstructive for the longitudinal movement of the passenger cell 2, is rendered superfluous.

1. A motor vehicle, the passenger cell of which is integrated into the rest of the vehicle as a separate unit, having a device, by means of which, in the event of a crash, the passenger cell can be moved in the longitudinal direction of the vehicle relative to the rest of the vehicle and at the same time upward, via guide surfaces, which are arranged on the rest of the vehicle and against which the passenger cell bears, wherein the device is designed in such a manner that the entire passenger cell (2) can be moved in the opposite direction to the impact in a translatory manner.

2. The motor vehicle as claimed in claim 1, wherein the device contains at least one sliding element (29), which is arranged along the longitudinal direction of the vehicle, can be actuated in the longitudinal direction of the vehicle by the impact force and is connected at one end to the passenger cell (2) over the entire crash path and at the other end bears an impact receptacle (26).

3. The motor vehicle as claimed in claim 2, wherein the sliding element (29) is fastened to a vehicle structure, which is situated essentially below the passenger cell (2) and has a section (12) which can be pushed together in the longitudinal direction of the vehicle and is moveable relative to the sliding element (29).

4. The motor vehicle as claimed in claim 3, wherein the section (12) is part of a longitudinal member (13) of the vehicle structure, on which the passenger cell (2) rests.

5. The motor vehicle as claimed in claim 3, wherein the section (12) is folded in the manner of a concertina, with it buckling in the transverse direction of the vehicle.

6. The motor vehicle as claimed in claim 3, wherein the vehicle structure comprises first components (18) and second components (19), the first components (18) being of hollow design and engaging around the second, with an overlapping zone (20) being formed and with an empty distance being left free, over which the second components (19) can be displaced in the first components (18) in the event of a crash, and in that the second components (19) with the first components (18) are fastened to one another in the zone (20) by a connection which can be sheared off in the crash.

7. The motor vehicle as claimed in claim 2, wherein the sliding element (29) is fitted to the front end and/or rear end (10, 11), and wherein the vehicle structure situated below the passenger cell (2) and the adjacent walls (27, 28) of the front end or rear end (10, 11) are designed in such a manner that, in the event of a crash, the structure penetrates the walls (27, 28).

8. The motor vehicle as claimed in claim 1, wherein the impact receptacle (26) of the sliding element (29) is mounted upstream of the passenger cell (2).

9. The motor vehicle as claimed in claim 2, wherein the sliding element (29) is operatively connected to a cable pull (34), which is fastened to the passenger cell (2) and is guided via deflection pulleys (35-39, 42-44) arranged on the rest of the vehicle, in such a manner that the passenger cell (2) is pulled upward by means of the cable pull (34) along the guide surfaces (15) in the opposite direction to the impact during a crash-induced displacement of the sliding element (29) relative to the passenger cell (2).

10. The motor vehicle as claimed in claim 9, wherein the cable pull (34) runs from one longitudinal side of the vehicle to the other, with the two ends (41, 45) of the cable pull (34) being fitted on the passenger cell (2) on different longitudinal sides of the vehicle.

11. The motor vehicle as claimed in claim 1, wherein the passenger cell (2) rests at the front and rear on the guide surfaces (15) which are parallel to one another and face obliquely upward to the impact direction.

12. The motor vehicle as claimed in claim 1, wherein the device contains a crash sensor and a compression or tension spring which is supported, on the one hand, on a splash wall (3) or back wall (4) of the passenger cell (2) and, on the other hand, on a stop formed on the rest of the vehicle, and in that the passenger cell (2) is locked to the rest of the vehicle, with the crash sensor canceling the locking after detection of an impact.

13. The motor vehicle as claimed in claim 1, wherein the device contains a crash sensor and a pyrotechnic device which is arranged between a splash wall (3), which faces the impact direction, or back wall (4) of the passenger cell (2) and an opposite wall (27, 28) of the rest of the vehicle, the crash sensor, after detection of an impact, using an electric signal to activate an igniter of the device that releases an explosive pressure.

14. The motor vehicle as claimed in claim 1, wherein the passenger cell (2) rests on rubber bearings (23) which are arranged on the rest of the vehicle.
